(19) United States
(12) Patent Application Publication
(10) Pub. No.: US 2017/0039295 A1
(43) Pub. Date: Feb. 9, 2017

(54) TRIBAL ABSTRACTION NETWORK

(71) Applicant: New Jersey Institute of Technology, Newark, NJ (US)

(72) Inventors: James Geller, West Orange, NJ (US); Yehoshua Perl, Forest Hills, NY (US); Christopher Ochs, Ocean Grove, NJ (US)

(21) Appl. No.: 14/821,415

(22) Filed: Aug. 7, 2015

(51) Int. Cl. G06F 17/30

(52) U.S. Cl. CPC G06F 17/30958; G06F 17/30598

(57) ABSTRACT

This invention relates to Tribal Abstraction Networks (TAN), a new type of Abstraction Network designed for hierarchies that do not have attribute relationships, assuming only the existence of multiple parents. A Tribal Association network can summarize the content and structure of terminology hierarchies and support their Quality Assurance (QA) by identifying concepts with a higher likelihood of incorrect or missing IS-A relationships.

This invention relates to Tribal Abstraction Networks (TAN), a new type of Abstraction Network designed for hierarchies that do not have attribute relationships, assuming only the existence of multiple parents. A Tribal Association network can summarize the content and structure of terminology hierarchies and support their Quality Assurance (QA) by identifying concepts with a higher likelihood of incorrect or missing IS-A relationships.

### BACKGROUND OF THE INVENTION

Abstraction Networks have been derived by summarization of terminologies based on their lateral (semantic) relationships. No Abstraction Networks have been derived for terminologies with an ISA (subclass) hierarchy without lateral relationships.

The Systematized Nomenclature of Medicine—Clinical Terms (SNOMED CT, SNOMED for short) is a large, leading medical terminology. Modeling errors and inconsistencies in a terminology of SNOMED's size and complexity are unavoidable. Quality assurance (QA) is an important part in the lifecycle of a terminology. However, identifying errors in large terminologies is a resource-intensive and error-prone task. The paradigm of Abstraction Networks (ANs) to support the QA of terminologies like SNOMED has been developed. An AN is a high level compact network that summarizes the content and structure of a large, complex terminology. ANs have been shown to support the identification of terminology concepts with a higher likelihood of errors when compared against a control sample.

The AN paradigm has been successfully applied as the Refined Semantic Network for the Unified Medical Language System (UMLS) and as the Schema for the Medical Entities Dictionary (MED). The area and partial-area taxonomy ANs were developed for the National Cancer Institute thesaurus (NCIt) and in for SNOMED hierarchies with attribute relationships (relationships for short). Furthermore, several types of ANs were developed for OWL-based ontologies including the Ontology of Clinical Research, the Sleep Domain Ontology, the Ontology for Drug Discovery Investigations, and the Cancer Chemoprevention Ontology. In the January 2013 release, SNOMED contained 297,801 active concepts divided into 19 hierarchies. SNOMED is hierarchically organized as a Directed Acyclic Graph (DAG) with 542,485 IS-A relationships. Additionally, concepts are linked together by 912,196 relationships. For example, the concept Heart sounds abnormal (in Clinical finding) has a relationship Interprets with a target concept Heart sounds (in Observable entity) (concept names and hierarchy names appear in Italics).

Viewing a large terminology visualization where nodes represent concepts and edges represent relationships, the resulting image would be overwhelming. Additionally, viewing a terminology through a concept-centric browser, such as CliniClue, hides the overall context of the concept. Often, only parents and children will be displayed alongside a selected concept. ANs summarize the content of an entire SNOMED hierarchy, based on the concept's structure and semantics. ANs were shown to support QA reviews for various terminological systems, e.g.,

### SUMMARY OF THE INVENTION

This invention relates to a Tribal Abstraction Network (TAN), a new type of AN designed for SNOMED hierarchies without attribute relationships. The TAN is derived assuming only the existence of multiple parents in a hierarchy. The TAN can be used to summarize the content and structure of such SNOMED hierarchies, as well as support their QA, by identifying concepts with a higher likelihood of incorrect or missing IS-A relationships. SNOMED is a large controlled medical terminology curated by the International Health Terminology Standards Development Organization (IHTSDO).

More particularly, this invention relates to a tribal abstraction network which is comprised of a summarization of a terminology with an ISA (subclass) hierarchy without lateral relationships wherein the children of the hierarchy's root are named patriarchs; a subhierarchy consisting of a patriarch and all its descents is named a tribe; every concept in the hierarchy belongs to at least one tribe; and all concepts belonging to a common set of tribes are grouped together into a set called a band.

In one embodiment, the TAN is a band tribal abstraction network consisting of a set of nodes representing bands within the tribal abstraction network where each band represents a set of all concepts that belong to a common set of tribes. The band may have multiple roots where each root defines a different subhierarchy of concepts within the band.

In another embodiment, the TAN is a cluster tribal abstraction network wherein a cluster is represented as a node of the cluster tribal abstraction. Each cluster represents a set of concepts consisting of a root of a band and all its descendant concepts within the same band.

Aspects of the TAN have been tested using SNOMED.

The invention also related to a method of deriving a TAN for a hierarchy identifying patriarchs which are the children of the hierarchy root; identifying tribes wherein each tribe is a subhierarchy consisting of a patriarch and all its descendants; and assigning each concept by its set of tribes by traversing the hierarchy using a topological sort starting from the hierarchy's patriarchs; wherein concepts that belong to multiple tribes are grouped into sets by specific combinations of tribes.

In another embodiment of the invention, the TAN is used to carry out quality assurance of a terminology with an ISA (subclass) hierarchy without lateral relationships using a TAN to identify large clusters within the tribal abstraction network and identifying the concepts belonging to large clusters at higher-numbered levels, and reviewing the identified concepts for errors.

### BRIEF DESCRIPTION OF THE FIGURES

So that those having ordinary skill in the art will have a better understanding of how to make and use the disclosed systems and methods, reference is made to the accompanying figures wherein:

FIG. 1 shows an excerpt of 20 concepts from the Observable entity hierarchy with abbreviated tribal names in braces.

FIG. 2 shows the concepts from FIG. 1 grouped by common tribal sets.

FIG. 3 shows the band TAN derived from FIG. 2. Each box represents a band. Child-of links are represented using arrows between bands.

FIG. 4 shows the cluster TAN derived from FIG. 2. Child-of links are represented by arrows between clusters.

FIG. 5 shows the Band Tribal Abstraction Network for the Observable entity hierarchy. Levels are organized into rows due to space limitations. Some child-of edges are hidden for readability.

FIG. 6 shows the Cluster Tribal Abstraction Network for Observable entity. Child-of edges are hidden for readability. Each level is organized into several rows due to space limitations. Level 1 (not shown) is the same as in FIG. 5.

### DETAILED DESCRIPTION OF THE INVENTION

Area and Partial-area Taxonomies for SNOMED, by utilizing relationships. These ANs were shown to support auditing of SNOMED hierarchies. Wei and Bodenreider showed that taxonomies support finding errors which cannot be discovered by classifiers such as Hermit and Fact++. Various semantic, structural, and ontological techniques are offered by Rector and by Schulz for quality assurance of SNOMED. For a summary of auditing techniques for SNOMED, see Zhu et al.

The area and partial-area taxonomies require a hierarchy having relationships. Within SNOMED, twelve hierarchies have no relationships and serve only as targets for relationships (“target hierarchies” for short). Thus, an alternative paradigm is suggested to design an AN for target hierarchies with multiple parents. In SNOMED, 102,826 concepts (34.5%) have multiple parents and the average number of parents is 1.822. Appendix I shows the number of concepts in each hierarchy having multiple parents and their percentage of each hierarchy. The number of concepts with multiple parents varies widely between different hierarchies, with almost half (45.26%) of the concepts in Clinical finding, compared to only 5.33% of the concepts in Observable entity. A new Abstraction Network for SNOMED target hierarchies with multiple parents has been developed.

Table 1 shows the number of concepts in each hierarchy having multiple parents as well as their percentage of each hierarchy. Eight of these 12 hierarchies contain more than 10 concepts with multiple parents.

TABLE 1
A breakdown by hierarchy of active
concepts with multiple parents.

| | # Active | # w/Multiple | % of |
|---|---|---|---|
| Hierarchy | Concepts | Parents | Hierarchy |
| Body structure | 31,117 | 13,339 | 42.9 |
| Clinical finding | 99,440 | 45,139 | 45.4 |
| Environment or geographical | 1,712 | 28 | 1.6 |
| location | | | |
| Event | 3,662 | 88 | 2.4 |
| Linkage concept | 1,131 | 0 | 0.0 |
| Observable entity | 8,274 | 439 | 5.3 |
| Organism | 32,776 | 1,195 | 3.6 |
| Pharmaceutical/biologic product | 17,146 | 7,727 | 45.1 |
| Physical force | 171 | 11 | 6.4 |
| Physical object | 4,522 | 383 | 8.5 |
| Procedure | 53,147 | 27,286 | 51.3 |
| Qualifier value | 8,984 | 750 | 8.4 |
| Record artifact | 223 | 2 | 0.9 |
| Situation with explicit context | 3,350 | 403 | 12.0 |
| Social context | 4,806 | 767 | 16.0 |
| Special concept | 802 | 0 | 0.0 |
| Specimen | 1,422 | 828 | 58.2 |
| Staging and scales | 1,305 | 1 | 0.08 |
| Substance | 23,822 | 4,445 | 18.7 |

The TAN addresses the need for summary methodologies for the eight target hierarchies of SNOMED with multiple parents. A TAN summary of a target hierarchy can be used to support QA. The number of concepts with multiple parents in a hierarchy is not as important for deriving a TAN as the locations where such concepts appear. Only 412 (5.33%) of the concepts in Observable entity have multiple parents, a relatively small number compared to several other hierarchies (Table 1), but a TAN is successfully derived, since 153 such concepts are located “at the crossroads” of tribe combinations.

The overall desired effect of using a TAN is to limit the resources for and increase the yield of QA. Concepts in the Observable entity hierarchy are more likely (4.85%) to be erroneous if they belong to large clusters in the TAN rather than to small clusters (1.40%). Furthermore, the percentage of errors is highest in a sample for large clusters of Level 3 and slightly higher in large clusters in Level 2 than Level 1. Following the methodology of the invention, the 86 and 773 concepts in large clusters of Levels 3 and 2, respectively, should be reviewed. These 86 concepts in Level 3 were reviewed and 11 errors were found. The number of errors expected in reviewing the 773 concepts of Level 2 is 28 (=0.0357×773) (Table 4). Hence, a total of 39 (=11+28) errors are expected from reviewing 859(=86+773) concepts in the large clusters of Levels 2 and 3, according to the methodology. Coincidentally, 39 erroneous concepts were also found when reviewing a random sample of 1160 concepts. Hence, the methodology would likely yield the same number of errors while saving the review of 301 (=1160-859) extra concepts (35%).

One issue arising from the placement of concepts with multiple parents in a hierarchy is the emergence of “super-large” Level 1 clusters, such as Clinical history/examination observable (4096) and Function (1384), together containing 67% of the Observable entity hierarchy. These clusters are too large and require further summarization. One can recursively derive a TAN for each such cluster, with its patriarch treated as a hierarchy root, thus creating a TAN to summarize its contents.

Similar to deriving a TAN for a super-large cluster, a TAN for a super-large root partial-area of a partial-area taxonomy can also be derived. For example, the single partial-area Procedure, which contains all concepts without lateral relationships, has 2518 concepts. A TAN for such a super-large root area will provide a summary of its content.

One can derive a TAN for all super-large partial-areas of a taxonomy. What is common to all concepts of such a partial-area is that they share the same root and set of relationships. Hence, for such large groups it is not possible to use relationships to obtain further division. However, one can ignore the relationships and derive a TAN for a super-large partial-area, summarizing its concepts. Examples of other super-large partial-areas in Procedure include Procedure by method (3684), Imaging by body site (1673), and Measurement of substance (3980). The use of TANs to complement partial-area taxonomy-based QA of large source hierarchies, e.g. the Procedure hierarchy is also contemplated as part of the instant invention. To support all of this research a tool for automatically deriving and visualizing TANs, similar to the BLUSNO tool created for SNOMED partial-area taxonomies is envisioned.

The phenomenon of concepts that overlap between clusters can also be studied. While bands are strictly disjoint, a concept may belong to multiple clusters. It is hypothesized that concepts in multiple clusters are more likely to contain errors due to being specifications of the roots of multiple clusters. While the Observable entity hierarchy has no such concepts, there are over 18,000 concepts that overlap between multiple clusters located throughout SNOMED's other hierarchies.

Thus, the Tribal Abstraction Network (TAN), an innovative Abstraction Network summarizing the content of hierarchies without relationships in SNOMED has been developed as described below. A TAN for the Observable entity hierarchy, summarizing the hierarchy's content has been derived. It has been found that concepts in large clusters have a statistically significantly higher likelihood of errors than concepts in small clusters. Furthermore, for large clusters, concepts of more tribes are likely to have more errors than concepts belonging to fewer tribes.

### Methods

The Tribal AN (TAN) is derived as follows. The children of a hierarchy's root are named patriarchs. A tribe is defined as a subhierarchy consisting of a patriarch and all its descendants. The use of the words “tribe” and “patriarch” follows the family tree paradigm (e.g. parents, children, and siblings). A tribe is named after its patriarch, since all its concepts are specializations of the patriarch. Every concept in a hierarchy, except for the hierarchy root, belongs to at least one tribe. In a TAN, all concepts belonging to a common set of tribes are grouped together. A necessary but not sufficient condition for a hierarchy to have concepts in multiple tribes is that there are concepts with multiple parents.

These definitions are illustrated using an excerpt from the Observable entity target hierarchy, which consists of concepts “representing a question or procedure which can produce an answer or a result”. In the January 2013 release this hierarchy contains 8,274 concepts linked by 8,726 IS-A relationships.

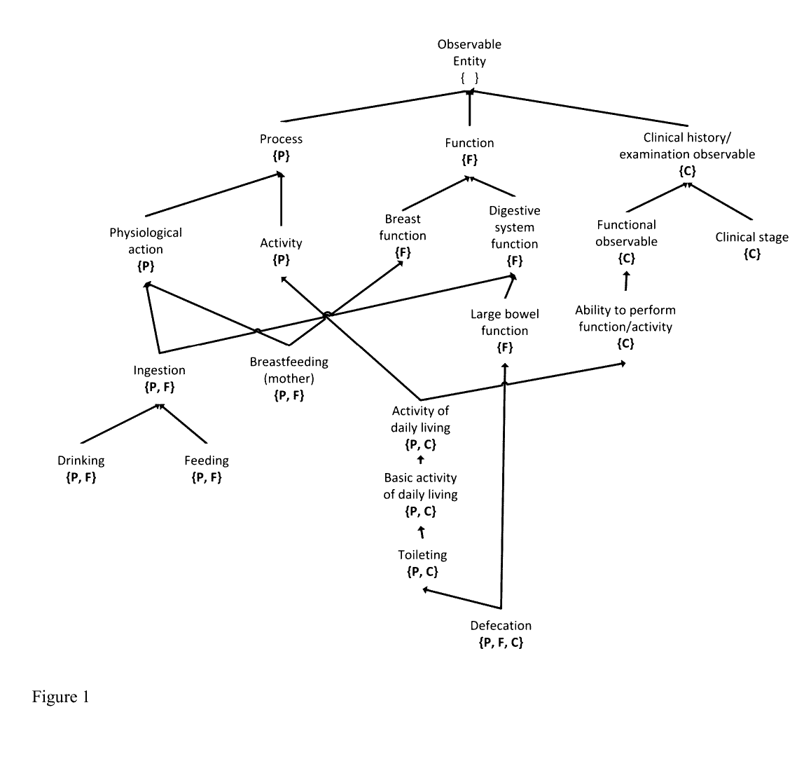

FIG. 1 shows a graphical representation for an excerpt of 20 concepts. Concepts are represented as nodes labeled with their respective names. Each of the children of Observable entity, e.g., Process, Function, and Clinical history/examination observable (shortened to Clinical history/exam), is a patriarch of a tribe. The tribal names are abbreviated such as P for Process, F for Function, and C for Clinical history/exam within braces below each name. Hierarchical IS-A links are represented as arrows. For example, Digestive system function IS-A Function. Physiological action, Activity, Ingestion, Drinking, Feeding, and Breastfeeding (mother) belong to the Process tribe since they are all descendants of Process.

Each concept is labeled by its set of tribes, called tribal set. To assign all concepts in a hierarchy to tribes, the hierarchy is traversed using topological sort starting from the hierarchy's patriarchs. Each patriarch is only assigned its own tribe. In a topological sort procedure any non-patriarch concept is processed only after all of its parents have been processed. If a concept c has one parent p₁ belonging to the tribe A and another parent p₂ belonging to the tribe B, c belongs to both tribes A and B, because it is a descendant of both patriarchs A and B. Once all parents of a concept c have been processed, c is assigned the union of its parents' tribal sets.

$$TribalSet ( c ) = {⋃}_{p ∈ Parents ( c )} TribalSet ( p )$$

This procedure is equivalent to, but generally more efficient than, performing a separate graph traversal from each hierarchy's patriarch, since each concept is only processed once. If a standard graph traversal, such as breadth first search were performed from each patriarch, concepts would have been processed multiples times, according to the number of tribes they belong to. For example, Defecation would have been processed three times, instead of only once using topological sort.

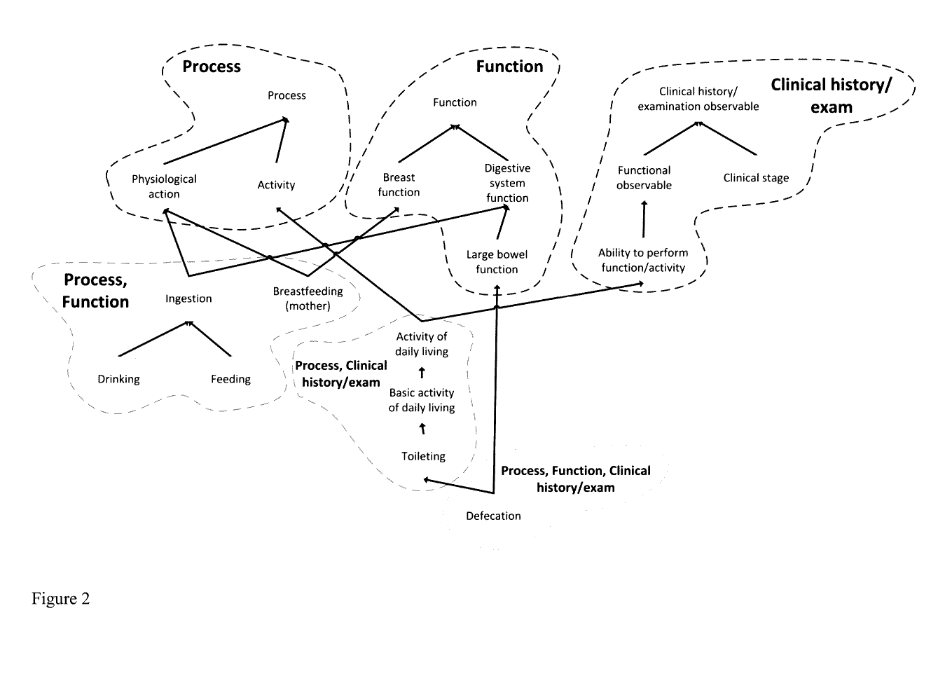

FIG. 1 shows the results of applying the tribal assignment process for an excerpt of 20 concepts. Tribal sets are shown in braces below each concept's name. FIG. 2 groups together the concepts with common tribal sets. Each group is represented by a dashed bubble and is labeled with the name(s) of the tribes.

Concepts that are descendants of only one patriarch will belong only to its tribe. In FIG. 2 Large bowel function belongs only to the Function tribe. Concepts, however, may belong to multiple tribes. In FIG. 2, Ingestion, Breastfeeding (mother), Activity of daily living, and Defecation all belong to more than one tribe, because each has multiple parents in different tribes. For example, Ingestion has two parents, Physiological action and Digestive system function, which belong to the Process and Function tribes, respectively. Ingestion, therefore, belongs to both the Process and Function tribes. Defecation belongs to all three tribes of this hierarchy. Even though Drinking, Feeding, Basic activity of daily living and Toileting each have only one parent, they belong to multiple tribes because each has an ancestor that belongs to multiple tribes.

Generally, concepts that belong to more than one tribe are more complex than those belonging to only one tribe, since they are specializations of several patriarch concepts. A concept that belongs to multiple tribes is called a joint concept. Joint-ness can be used to group concepts into sets. These sets can be used to derive two kinds of TANs: the Band Tribal Abstraction Network (“Band TAN”) and the more refined Cluster Tribal Abstraction Network (“Cluster TAN”).

### Band Tribal Abstraction Network

A tribal band, or band for short, is a set of all concepts that are members of the exact same tribes. A band is named after the set of tribes each concept within the band belongs to. A root of a band is a concept that has no parents within the band, though it may have parents in other bands. A band may have multiple roots. Each set of concepts, surrounded by a dashed bubble (FIG. 2), defines a band.

A band TAN consists of one node for each band. These nodes are linked by hierarchical child-of relationships derived from the underlying IS-A hierarchy of the terminology. A band A is a child-of another band B if and only if every root concept in A has an IS-A link to a concept in B. A band may be child-of multiple bands. The band TAN provides a compact, abstract view of a hierarchy lacking relationships.

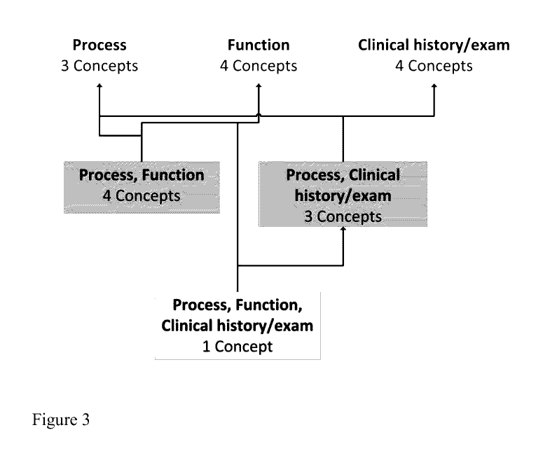

FIG. 3 shows the band TAN for FIG. 1 obtained using the tribal sets from FIG. 2. The number of concepts is listed under each band's name. The four concepts Ingestion, Feeding, Drinking, and Breastfeeding (mother) belong to the band named {Process, Function}. Ingestion and Breastfeeding (mother) are the roots of the {Process, Function} band, because neither has parents in the {Process, Function} band. The band {Process, Function} is a child-of two bands, {Process} and {Function}, because both roots Ingestion and Breastfeeding (mother) have parents in both of these bands.

The band {Process, Function, Clinical history/exam} is a child-of both bands {Process, Clinical history/exam} and {Function} because its root Defecation has two parents, Toileting in {Process, Clinical history/exam} and Large bowel function in {Function}.

Each band has a degree of “joint-ness” according to the number of tribes its members belong to. Bands containing concepts of only one tribe consist of the tribal patriarch and all of its descendants which are not descendants of a second patriarch.

In visualizations of band TANs, (FIGS. 3 and 5), tribal bands are organized into levels according to their degrees of joint-ness and are color-coded. Bands of degree 1 are located at the top of the figure. Bands of degree 2, with concepts that belong to two tribes are below.

### Cluster Tribal Abstraction Network

A tribal band may have multiple roots. Each root defines a different subhierarchy of concepts within the band. A tribal cluster, or cluster for short, consists of a root of a band and all its descendants within the same band. A tribal cluster is named after its root because all other concepts in the cluster are specializations of the root.

Clusters are used to further refine the band TAN into the cluster TAN. In a cluster TAN, the clusters serve as the nodes, where all the clusters of a band are drawn within that band node. Clusters, like bands, are linked by child-of relationships based on the underlying IS-A hierarchy. A cluster A is a child-of another cluster B if the root concept of A has an IS-A link to a concept in B. A cluster may be a child-of multiple clusters.

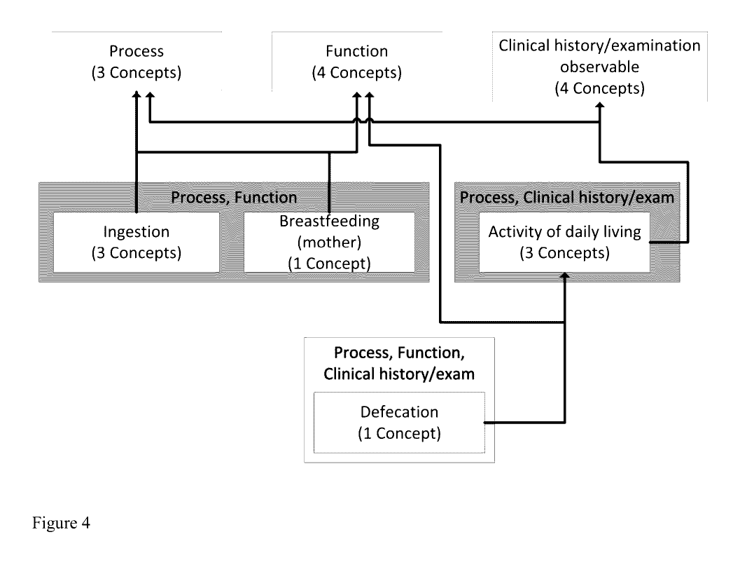

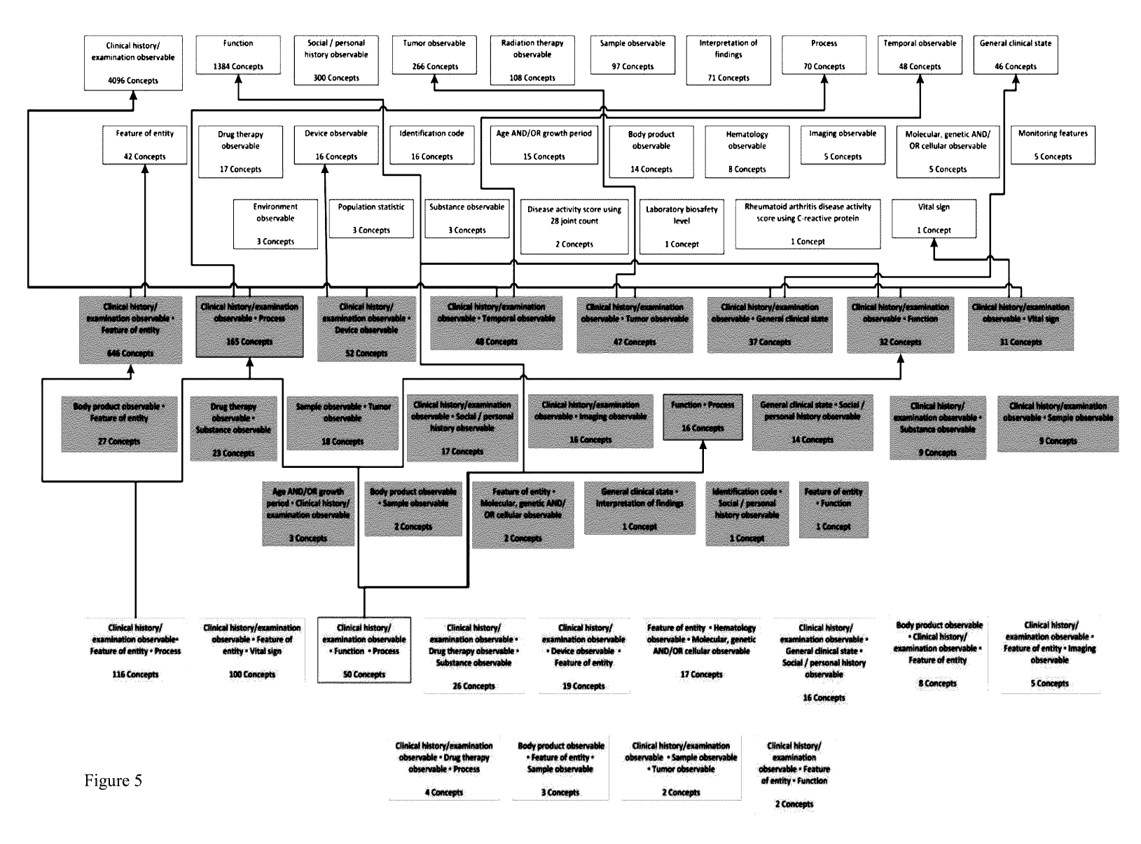

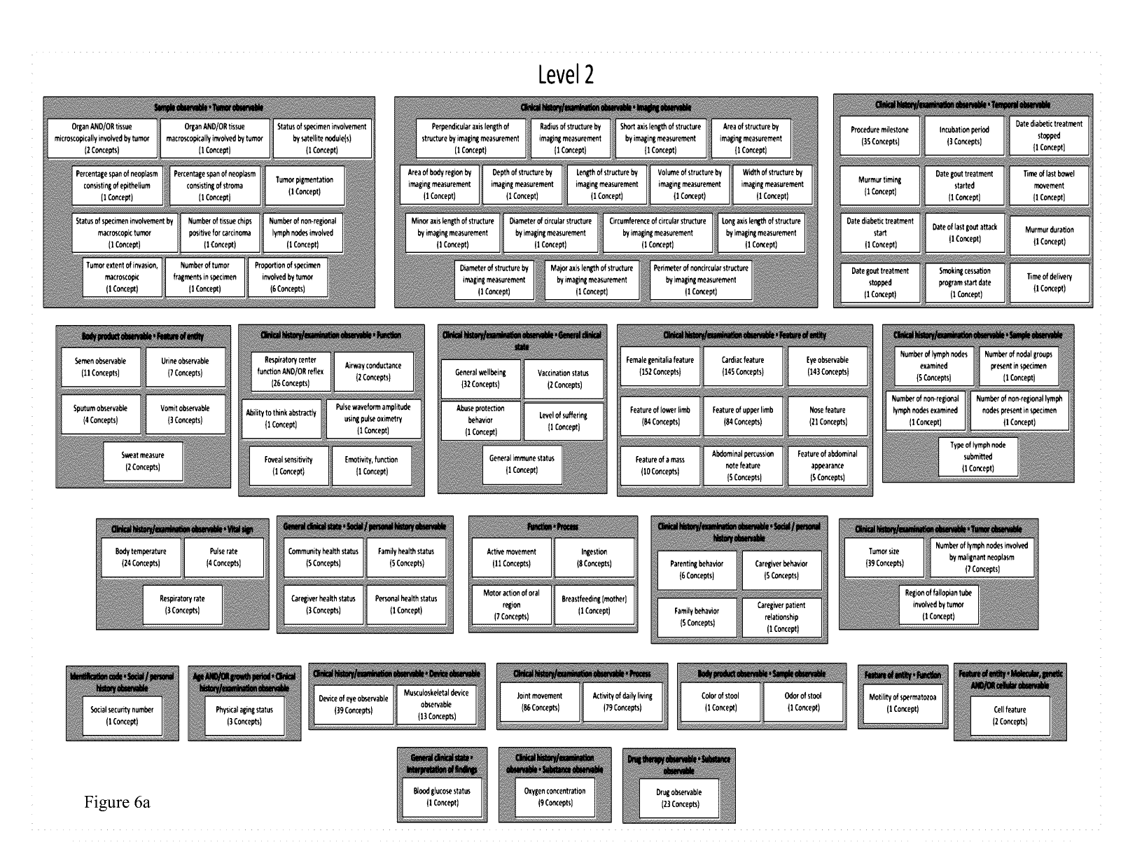

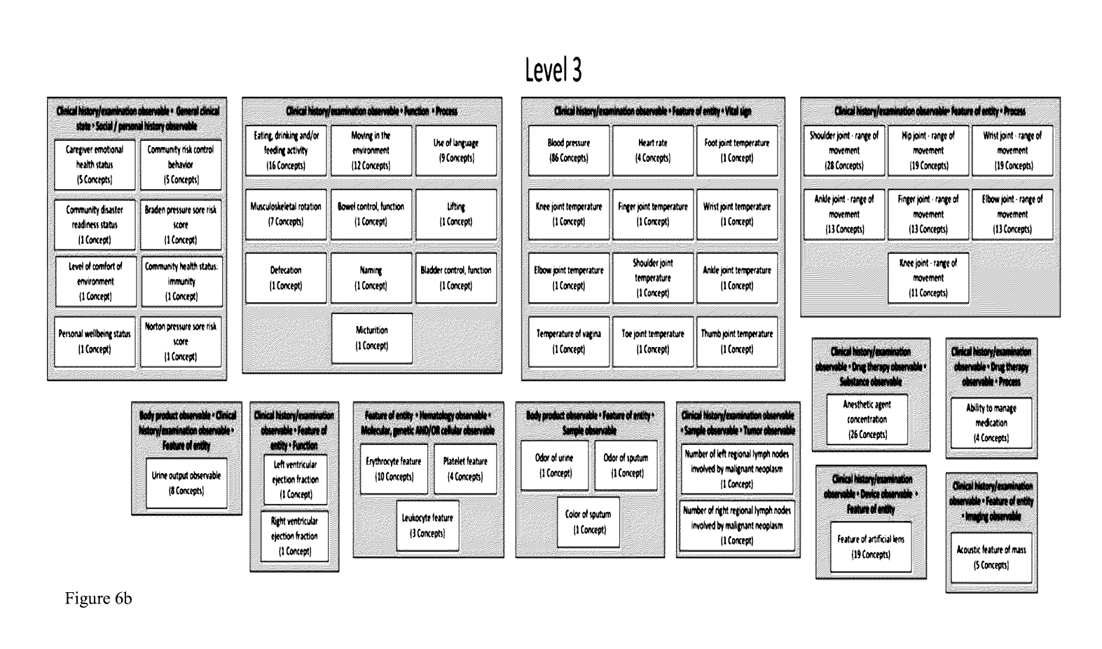

In FIG. 2, Ingestion and Breastfeeding (mother) are the two roots of the {Process, Function} band. In visualizations of a cluster TAN (FIGS. 4 and 6), clusters are represented as white boxes within a band box, labeled by their roots, with their numbers of concepts below the root names. The root Ingestion and its two descendants are represented as a cluster named Ingestion of three concepts in the {Process, Function} band (FIG. 4). The Ingestion cluster is a child-of the Process and Function clusters because the root concept Ingestion has parents in these two clusters.

### Tribal Abstraction Networks for Quality Assurance

Quality assurance (QA) of large terminologies is difficult and time consuming. By focusing QA efforts on a subset of concepts that are likely to be more error prone, QA resources can be utilized more effectively. It has been shown that ANs support terminology QA by identifying such concepts. The TAN can also be used to support SNOMED QA efforts by identifying concepts more likely to have more hierarchical errors. Such errors were deemed to be the most problematic in a previous study of SNOMED's users. IS-A relationships play an important definitional role for concepts in SNOMED. For target hierarchies the correctness of the IS-A hierarchy is important, because the concepts of these hierarchies serve as targets for relationships with source concepts in other hierarchies. There are 18,839 relationships with targets in Observable entity. Proper placement of target concepts in a hierarchy is crucial since the target of a relationship should be as specific as possible.

Hypothesis 1: In a cluster TAN, concepts in large clusters will likely have more errors than concepts in small clusters.

The rationale for Hypothesis 1 is as follows. For a concept in a target hierarchy (without relationships) to be erroneous, the errors can occur only in the hierarchy. An IS-A relationship for a concept may be either wrong or missing and the concept is misplaced in the hierarchy. There is a greater chance for such situations to occur in large clusters, because as the number of hierarchically closely related concepts increases, the chance of a concept being misplaced in the hierarchy also increases. In clusters with fewer concepts, there is less chance of a concept being misplaced in the hierarchy. This hypothesis was tested using a cluster TAN derived from the Observable entity hierarchy.

To reiterate, the goal is to minimize the number of concepts that should be the focus of a QA review by selecting few concepts with a high likelihood of errors. Such a portion can be reviewed with available limited QA resources and yield a large number of errors, relative to the effort spent.

However, auditing all large clusters is generally not practical because of their large number of concepts. Therefore, a second hypothesis was introduced based on the level a concept belongs to. (Reminder: Level numbers grow higher when moving downward in a band diagram.)

Hypothesis 2: Among the large clusters, those concepts belonging to higher-numbered levels are likely to have more errors.

The rationale for this hypothesis is that concepts belonging to more tribes tend to be more complex due to their specialization of more patriarchs. The modeling of more complex concepts is more prone to errors. Assuming there is support for these two hypotheses, the following auditing methodology is emerging. Start reviewing the large clusters of the highest-numbered level. As long as QA resources remain, continue to review large clusters moving up in the diagram.

### Results

A cluster TAN was derived for the July 2011 version of the Observable entity hierarchy. Even though Observable entity has few concepts with multiple parents (Table 2), a cluster TAN summarizes the content and structure of this hierarchy well (Table 3). There are 27 children of Observable entity and therefore 27 tribes with 16 (59.3%) of these tribes having joint concepts while 11 tribes do not. The maximum number of tribes a concept belongs to is three, while 6,627 (80.5%) concepts of a unique tribe belong to the 27 tribal bands on the first level. The second level comprises 1,236 concepts (15%) of the hierarchy and the third level 368 (4.47%). The percentage of concepts with multiple parents is much higher in Levels 2 and 3 (14% and 20%) than in Level 1 (2.5%). FIGS. 5 and 6 provide visualizations of the band TAN and the cluster TAN.

The TAN summarizes a target hierarchy. The bands of Level 1 indicate the major types of concepts in a hierarchy; Level 1 of FIG. 5 contains many Clinical history/examination and Function concepts. Levels 2 and 3 show how the bands of Level 1 intersect in the hierarchy, e.g. the Clinical history/examination observable band intersects with most other bands. FIG. 6 allows identifying common concept groups of multiple tribes. For example, looking at the very larger clusters, such as Female genital feature (152), Cardiac feature (145), Eye observable (143), followed by the large clusters Blood pressure (86), and Activity of daily living (79), Joint movement (86), Feature of lower limb (84), and Feature of upper limb (84), provides a summarization of the major types of concepts in the Observable entity hierarchy. For a finer summary, one should view the “medium” sized clusters of 25-50 concepts, e.g. Device of eye observable (39), Tumor size (35), Shoulder joint—range of movement (28), and Anesthetic agent concentration (26). Hence, by looking at the 15 clusters with at least 25 concepts, the TAN summarizes 1084 concepts (68.3%) of the major subjects in Levels 2 and 3.

TABLE 2
A breakdown by hierarchy of active
concepts with multiple parents.

| | # Active | # w/Multiple | % of |
|---|---|---|---|
| Hierarchy | Concepts | Parents | Hierarchy |
| Body structure* | 31,117 | 13,339 | 42.9 |
| Clinical finding* | 99,440 | 45,139 | 45.4 |
| Environment or geographical | 1,712 | 28 | 1.6 |
| location | | | |
| Event* | 3,662 | 88 | 2.4 |
| Linkage concept | 1,131 | 0 | 0.0 |
| Observable entity | 8,274 | 439 | 5.3 |
| Organism | 32,776 | 1,195 | 3.6 |
| Pharmaceutical/biologic product* | 17,146 | 7,727 | 45.1 |
| Physical force | 171 | 11 | 6.4 |
| Physical object | 4,522 | 383 | 8.5 |
| Procedure* | 53,147 | 27,286 | 51.3 |
| Qualifier value | 8,984 | 750 | 8.4 |
| Record artifact | 223 | 2 | 0.9 |
| Situation with explicit context* | 3,350 | 403 | 12.0 |
| Social context | 4,806 | 767 | 16.0 |
| Special concept | 802 | 0 | 0.0 |
| Specimen* | 1,422 | 828 | 58.2 |
| Staging and scales | 1,305 | 1 | 0.08 |
| Substance | 23,822 | 4,445 | 18.7 |

An asterisk indicates that the hierarchy has attribute relationships.

TABLE 3
Summary of the Observable entity hierarchy's band and cluster TANs.

| | | # | # | | | | |
|---|---|---|---|---|---|---|---|
| | # | Clus- | Con- | # in | # in | # (%) w/ | Avg # |
| Level | Bands | ters | cepts | Large | Small | Multiple | Parents |
| 1 | 27 | 27 | 6,643 | 6392 | 251 | 169 (2.5%) | 1.03 |
| 2 | 23 | 101 | 1,220 | 773 | 447 | 170 (14% ) | 1.14 |
| 3 | 13 | 52 | 368 | 86 | 282 | 73 (20%) | 1.21 |
| TOTAL | 63 | 180 | 8231 | 7251 | 980 | 412 (5.3%) | 1.06 |

To test hypotheses, 1160 concepts (14.1%) from Observable entity were reviewed. 410 concepts were audited from Level 1; 474 from Level 2; and 266 from Level 3. At each level all concepts from clusters of 9 concepts or fewer (284 in total) and randomly selected concepts from clusters containing 10 or more concepts (876 total) were audited. In total, 39 errors (3.36%) were found in the sample. Twenty-one concepts had incorrect IS-A relationships and 18 had missing IS-A relationships. Table 4 provides a list of the erroneous concepts uncovered during the quality assurance review of the Observable entity hierarchy, along with the identified error(s) and the auditor's suggested solutions. Note that missing or incorrect child errors can be restated as missing or incorrect parents, respectively, on the child concept. However, the errors as they were identified by the auditor. All identified errors were reported through the US SNOMED CT Content Request System (USCRS).

TABLE 4
List of Identified Errors and Proposed Solutions

| | | | | | |
|---|---|---|---|---|---|
| | Erroneous | | Error | | Target |
| # | Concept Name | Current parents | Type | Solution | Concept(s) |

Errors of Omission

| | | | | | |
|---|---|---|---|---|---|
| 1 | Binding capacity | General metabolic | Missing | Add Is a | Protein binding capacity |
| | | function | child | FROM | |
| 2 | Osmotic pressure | Fluid observable | Missing | Add Is a | Oncotic pressure |
| | | | child | FROM | |
| 3 | Physical activity | Exercise history | Missing | Add Is a | Target physical activity |
| | | | child | FROM | |
| 4 | Sitting blood pressure | Systolic blood pressure | Missing | Add Is a | Sitting systolic blood |
| | | and Diastolic blood | child | FROM | pressure, Sitting diastolic |
| | | pressure, respectively. | | | blood pressure |
| 5 | 24 hour diastolic blood | 24 hour blood pressure | Missing | Add Is a TO | Diastolic blood pressure |
| | pressure | | parent | | |
| 6 | Ability to kneel in bath | Ability to perform | Missing | Add Is a TO | Ability to kneel |
| | | bathing activity | parent | | |
| 7 | Autonomic bladder | Autonomic nervous | Missing | Add Is a TO | Bladder function |
| | function | system function | parent | | |
| 8 | Bath ankylosing | Joint movement | Missing | Add Is a TO | Functional observable |
| | spondylitis metrology | | parent | | |
| | index score | | | | |
| 9 | Date chemotherapy | Drug therapy observable | Missing | Add Is a TO | Temporal observable |
| | completed | | parent | | |
| 10 | Frequency of uterine | Pattern of uttering | Missing | Add Is a TO | Measure of uterine |
| | contraction | contractions | parent | | contractions |
| 11 | Interval between uterine | Measure of uterine | Missing | Add Is a TO | Pattern of uterine |
| | contractions | contractions | parent | | contractions |
| 12 | Invasive arterial | Invasive blood pressure | Missing | Add Is a TO | Arterial blood pressure |
| | pressure | | parent | | |
| 13 | Invasive mean arterial | Mean blood pressure | Missing | Add Is a TO | Invasive arterial pressure |
| | pressure | | parent | | |
| 14 | Percentage span of | Microscopic specimen | Missing | Add Is a TO | Specimen measurable |
| | neoplasm consisting of | observable and Tumor | parent | | |
| | stroma | observable | | | |
| 15 | Post-vasodilatation | Blood pressure | Missing | Add Is a TO | Arterial blood pressure |
| | arterial pressure | | parent | | |
| 16 | Strength of uterine | Pattern of uterine | Missing | Add Is a TO | Measure of uterine |
| | contraction | contractions | parent | | contractions |
| 17 | Uterine contraction | Measure of uterine | Missing | Add Is a TO | Pattern of uterine |
| | intensity | contractions | parent | | contractions |
| 18 | Venous velocity | Venous measure | Missing | Add Is a TO | Blood velocity |
| | | | parent | | |

Errors of Commission

| | | | | | |
|---|---|---|---|---|---|
| 19 | Community health status | | Incorrect | Remove Is a | Community competence |
| | | | Child | FROM | capacity, Community |
| | | | | | disaster readiness status, |
| | | | | | Community risk control |
| | | | | | behavior |
| 20 | Active wrist movements | Active movements | Incorrect | Replace with | Active upper limb |
| | | | parent | Is a TO | movements |
| 21 | Ankle joint temperature | Body temperature and | Incorrect | Replace with | Joint temperature |
| | | Feature of ankle joint | parent | Is a TO | |
| 22 | Detail of history of | Social/personal history | Incorrect | Replace with | Detail of history of travel |
| | foreign travel | observable | parent | Is a TO | |
| 23 | Dorsalis pedis arterial | Blood pressure | Incorrect | Replace with | Arterial blood pressure |
| | pressure | | parent | Is a TO | |
| 24 | Eating | Feeding | Incorrect | Replace with | Eating, drinking and/or |
| | | | parent | Is a TO | feeding activity |
| 25 | Fetal heart rate | Feature of fetal heart rate | Incorrect | Replace with | Fetal heart feature |
| | | | parent | Is a TO | |
| 26 | Heart sounds | Characteristic of heart | Incorrect | Replace with | Cardiac feature |
| | | sound | parent | Is a TO | |
| 27 | Horizontal diameter of | Optic disc observable | Incorrect | Replace with | Optic disc size |
| | optic disc | | parent | Is a TO | |
| 28 | Infant feeding method at | Characteristic of infant | Incorrect | Replace with | Infant feeding method |
| | 1 year | feeding | parent | Is a TO | |
| 29 | Left ventricular index of | Cardiac feature | Incorrect | Replace with | Feature of left ventricle |
| | myocardium performance | | parent | Is a TO | |
| 30 | Number of admissions | Temporal observable | Incorrect | Replace with | Suggested new |
| | | | parent | Is a TO | concept: Number of |
| | | | | | occurrences observable |
| 31 | Number of appointments | Temporal observable | Incorrect | Replace with | Suggested new |
| | attended | | parent | Is a TO | concept: Number of |
| | | | | | occurrences observable |
| 32 | Number of appointments | Temporal observable | Incorrect | Replace with | Suggested new |
| | missed | | parent | Is a TO | concept: Number of |
| | | | | | occurrences observable |
| 33 | Pulmonary vein mean | Venous wedge pressure | Incorrect | Replace with | Pulmonary vein wedge |
| | wedge pressure | | parent | Is a TO | pressure |
| 34 | Pulmonary vein wedge | Venous wedge pressure | Incorrect | Replace with | Pulmonary vein wedge |
| | pressure - a wave | | parent | Is a TO | pressure |
| 35 | Pulmonary vein wedge | Venous wedge pressure | Incorrect | Replace with | Pulmonary vein wedge |
| | pressure - v wave | | parent | Is a TO | pressure |
| 36 | Pulmonary vein wedge | Venous wedge pressure | Incorrect | Replace with | Pulmonary vein wedge |
| | pressure - x trough | | parent | Is a TO | pressure |
| 37 | Pulmonary vein wedge | Venous wedge pressure | Incorrect | Replace with | Pulmonary vein wedge |
| | pressure - y trough | | parent | Is a TO | pressure |
| 38 | Sweat measure | Body fluid property and | Incorrect | Replace with | Sweating observable |
| | | Body product observable | parent | Is a TO | |
| 39 | Turbidity of fluid | Fluid observable | Incorrect | Replace with | Turbidity |
| | | | parent | Is a TO | |

To test Hypothesis 1, the relationship between cluster size and error rate was studied as follows. To handle correlation of concepts within clusters, x the data were analyzed at the cluster level by calculating the error rate per cluster (i.e., for each cluster, the total number of erroneous concepts divided by the total number of sample concepts in the cluster). To better visualize the effect of cluster size, and because the relation between cluster size and error rate might not be linear, we stratified clusters into six bins. The per-cluster analysis is shown in Table 5.

TABLE 5
Per-cluster error analysis.

| | Cluster | | Sample | Erroneous | Erroneous |
|---|---|---|---|---|---|
| Cluster Root | Size | Level | Concepts | Concepts | Concept Rate |
| Clinical history/examination | 4096 | 1 | 93 | 3 | 3.23% |
| observable | | | | | |
| Function | 1384 | 1 | 35 | 1 | 2.86% |
| Social/personal history | 300 | 1 | 19 | 1 | 5.26% |
| observable | | | | | |
| Tumor observable | 266 | 1 | 14 | 1 | 7.14% |
| Radiation therapy observable | 108 | 1 | 6 | 0 | 0.00% |
| Sample observable | 97 | 1 | 16 | 0 | 0.00% |
| Interpretation of findings | 71 | 1 | 12 | 0 | 0.00% |
| Process | 70 | 1 | 15 | 0 | 0.00% |
| Temporal observable | 48 | 1 | 41 | 3 | 7.32% |
| General clinical state | 46 | 1 | 37 | 0 | 0.00% |
| Feature of entity | 42 | 1 | 34 | 3 | 8.82% |
| Drug therapy observable | 17 | 1 | 14 | 1 | 7.14% |
| Device observable | 16 | 1 | 14 | 0 | 0.00% |
| Identification code | 16 | 1 | 13 | 0 | 0.00% |
| Age AND/OR growth period | 15 | 1 | 11 | 0 | 0.00% |
| Body product observable | 14 | 1 | 9 | 0 | 0.00% |
| Hematology observable | 8 | 1 | 8 | 0 | 0.00% |
| Monitoring features | 5 | 1 | 5 | 0 | 0.00% |
| Imaging observable | 5 | 1 | 5 | 0 | 0.00% |
| Molecular, genetic AND/OR | 5 | 1 | 5 | 0 | 0.00% |
| cellular observable | | | | | |
| Substance observable | 3 | 1 | 3 | 0 | 0.00% |
| Population statistic | 3 | 1 | 3 | 0 | 0.00% |
| Environment observable | 3 | 1 | 3 | 0 | 0.00% |
| Disease activity score using | 2 | 1 | 2 | 0 | 0.00% |
| 28 joint count | | | | | |
| Vital sign | 1 | 1 | 1 | 0 | 0.00% |
| Laboratory biosafety level | 1 | 1 | 1 | 0 | 0.00% |
| Rheumatoid arthritis disease | 1 | 1 | 1 | 0 | 0.00% |
| activity score using C-reactive | | | | | |
| protein | | | | | |
| Female genitalia feature | 152 | 2 | 58 | 4 | 6.90% |
| Cardiac feature | 145 | 2 | 45 | 3 | 6.67% |
| Eye observable | 143 | 2 | 42 | 1 | 2.38% |
| Joint movement | 86 | 2 | 26 | 1 | 3.85% |
| Feature of upper limb | 84 | 2 | 27 | 0 | 0.00% |
| Feature of lower limb | 84 | 2 | 26 | 0 | 0.00% |
| Activity of daily living | 79 | 2 | 28 | 0 | 0.00% |
| Tumor size | 39 | 2 | 4 | 0 | 0.00% |
| Device of eye observable | 39 | 2 | 3 | 0 | 0.00% |
| Procedure milestone | 35 | 2 | 3 | 0 | 0.00% |
| General wellbeing | 32 | 2 | 3 | 0 | 0.00% |
| Respiratory center function | 26 | 2 | 2 | 0 | 0.00% |
| AND/OR reflex | | | | | |
| Body temperature | 24 | 2 | 2 | 0 | 0.00% |
| Drug observable | 23 | 2 | 3 | 0 | 0.00% |
| Nose feature | 21 | 2 | 2 | 0 | 0.00% |
| Musculoskeletal device | 13 | 2 | 10 | 0 | 0.00% |
| observable | | | | | |
| Semen observable | 11 | 2 | 10 | 0 | 0.00% |
| Active movement | 10 | 2 | 8 | 1 | 12.50% |
| Feature of a mass | 10 | 2 | 8 | 0 | 0.00% |
| Oxygen concentration | 9 | 2 | 9 | 0 | 0.00% |
| Urine observable | 7 | 2 | 7 | 0 | 0.00% |
| Number of lymph nodes | 7 | 2 | 7 | 0 | 0.00% |
| involved by malignant | | | | | |
| neoplasm | | | | | |
| Proportion of specimen | 6 | 2 | 6 | 0 | 0.00% |
| involved by tumor | | | | | |
| Parenting behavior | 6 | 2 | 6 | 0 | 0.00% |
| Abdominal percussion note | 5 | 2 | 5 | 0 | 0.00% |
| feature | | | | | |
| Feature of abdominal | 5 | 2 | 5 | 0 | 0.00% |
| appearance | | | | | |
| Family health status | 5 | 2 | 5 | 0 | 0.00% |
| Community health status | 5 | 2 | 5 | 1 | 20.00% |
| Caregiver behavior | 5 | 2 | 5 | 0 | 0.00% |
| Family behavior | 5 | 2 | 5 | 0 | 0.00% |
| Number of lymph nodes | 5 | 2 | 5 | 0 | 0.00% |
| examined | | | | | |
| Pulse rate | 4 | 2 | 4 | 0 | 0.00% |
| Sputum observable | 4 | 2 | 4 | 0 | 0.00% |
| Motor action of oral region | 4 | 2 | 4 | 0 | 0.00% |
| Respiratory rate | 3 | 2 | 3 | 0 | 0.00% |
| Vomit observable | 3 | 2 | 3 | 0 | 0.00% |
| Physical aging status | 3 | 2 | 3 | 0 | 0.00% |
| Caregiver health status | 3 | 2 | 3 | 0 | 0.00% |
| Incubation period | 3 | 2 | 3 | 0 | 0.00% |
| Airway conductance | 2 | 2 | 2 | 0 | 0.00% |
| Sweat measure | 2 | 2 | 2 | 1 | 50.00% |
| Organ AND/OR tissue | 2 | 2 | 2 | 0 | 0.00% |
| microscopically involved by | | | | | |
| tumor | | | | | |
| Vaccination status | 2 | 2 | 2 | 0 | 0.00% |
| Cell feature | 2 | 2 | 2 | 0 | 0.00% |
| Emotivity, function | 1 | 2 | 1 | 0 | 0.00% |
| Motility of spermatozoa | 1 | 2 | 1 | 0 | 0.00% |
| Ingestion | 1 | 2 | 1 | 0 | 0.00% |
| Odor of stool | 1 | 2 | 1 | 0 | 0.00% |
| Color of stool | 1 | 2 | 1 | 0 | 0.00% |
| Date gout treatment started | 1 | 2 | 1 | 0 | 0.00% |
| Date of last gout attack | 1 | 2 | 1 | 0 | 0.00% |
| Date gout treatment stopped | 1 | 2 | 1 | 0 | 0.00% |
| Date diabetic treatment start | 1 | 2 | 1 | 0 | 0.00% |
| Date diabetic treatment | 1 | 2 | 1 | 0 | 0.00% |
| stopped | | | | | |
| General immune status | 1 | 2 | 1 | 0 | 0.00% |
| Ability to think abstractly | 1 | 2 | 1 | 0 | 0.00% |
| Number of tumor fragments | 1 | 2 | 1 | 0 | 0.00% |
| in specimen | | | | | |
| Type of lymph node | 1 | 2 | 1 | 0 | 0.00% |
| submitted | | | | | |
| Tumor extent of invasion, | 1 | 2 | 1 | 0 | 0.00% |
| macroscopic | | | | | |
| Status of specimen | 1 | 2 | 1 | 0 | 0.00% |
| involvement by satellite | | | | | |
| nodule(s) | | | | | |
| Tumor pigmentation | 1 | 2 | 1 | 0 | 0.00% |
| Number of nodal groups | 1 | 2 | 1 | 0 | 0.00% |
| present in specimen | | | | | |
| Time of delivery | 1 | 2 | 1 | 0 | 0.00% |
| Social security number | 1 | 2 | 1 | 0 | 0.00% |
| Region of fallopian tube | 1 | 2 | 1 | 0 | 0.00% |
| involved by tumor | | | | | |
| Status of specimen | 1 | 2 | 1 | 0 | 0.00% |
| involvement by macroscopic | | | | | |
| tumor | | | | | |
| Organ AND/OR tissue | 1 | 2 | 1 | 0 | 0.00% |
| macroscopically involved by | | | | | |
| tumor | | | | | |
| Number of tissue chips | 1 | 2 | 1 | 0 | 0.00% |
| positive for carcinoma | | | | | |
| Number of non-regional | 1 | 2 | 1 | 0 | 0.00% |
| lymph nodes involved | | | | | |
| Number of non-regional | 1 | 2 | 1 | 0 | 0.00% |
| lymph nodes examined | | | | | |
| Number of non-regional | 1 | 2 | 1 | 0 | 0.00% |
| lymph nodes present in | | | | | |
| specimen | | | | | |
| Smoking cessation program | 1 | 2 | 1 | 0 | 0.00% |
| start date | | | | | |
| Level of suffering | 1 | 2 | 1 | 0 | 0.00% |
| Personal health status | 1 | 2 | 1 | 0 | 0.00% |
| Caregiver patient relationship | 1 | 2 | 1 | 0 | 0.00% |
| Blood glucose status | 1 | 2 | 1 | 0 | 0.00% |
| Abuse protection behavior | 1 | 2 | 1 | 0 | 0.00% |
| Breastfeeding (mother) | 1 | 2 | 1 | 0 | 0.00% |
| Murmur timing | 1 | 2 | 1 | 0 | 0.00% |
| Foveal sensitivity | 1 | 2 | 1 | 0 | 0.00% |
| Murmur duration | 1 | 2 | 1 | 0 | 0.00% |
| Time of last bowel movement | 1 | 2 | 1 | 0 | 0.00% |
| Pulse waveform amplitude | 1 | 2 | 1 | 0 | 0.00% |
| using pulse oximetry | | | | | |
| Short axis length of structure | 1 | 2 | 1 | 0 | 0.00% |
| by imaging measurement | | | | | |
| Radius of structure by | 1 | 2 | 1 | 0 | 0.00% |
| imaging measurement | | | | | |
| Area of structure by imaging | 1 | 2 | 1 | 0 | 0.00% |
| measurement | | | | | |
| Circumference of circular | 1 | 2 | 1 | 0 | 0.00% |
| structure by imaging | | | | | |
| measurement | | | | | |
| Diameter of circular structure | 1 | 2 | 1 | 0 | 0.00% |
| by imaging measurement | | | | | |
| Volume of structure by | 1 | 2 | 1 | 0 | 0.00% |
| imaging measurement | | | | | |
| Length of structure by | 1 | 2 | 1 | 0 | 0.00% |
| imaging measurement | | | | | |
| Long axis length of structure | 1 | 2 | 1 | 0 | 0.00% |
| by imaging measurement | | | | | |
| Depth of structure by imaging | 1 | 2 | 1 | 0 | 0.00% |
| measurement | | | | | |
| Major axis length of structure | 1 | 2 | 1 | 0 | 0.00% |
| by imaging measurement | | | | | |
| Minor axis length of structure | 1 | 2 | 1 | 0 | 0.00% |
| by imaging measurement | | | | | |
| Diameter of structure by | 1 | 2 | 1 | 0 | 0.00% |
| imaging measurement | | | | | |
| Area of body region by | 1 | 2 | 1 | 0 | 0.00% |
| imaging measurement | | | | | |
| Perpendicular axis length of | 1 | 2 | 1 | 0 | 0.00% |
| structure by imaging | | | | | |
| measurement | | | | | |
| Width of structure by imaging | 1 | 2 | 1 | 0 | 0.00% |
| measurement | | | | | |
| Perimeter of noncircular | 1 | 2 | 1 | 0 | 0.00% |
| structure by imaging | | | | | |
| measurement | | | | | |
| Percentage span of neoplasm | 1 | 2 | 1 | 1 | 100.00% |
| consisting of stroma | | | | | |
| Percentage span of neoplasm | 1 | 2 | 1 | 0 | 0.00% |
| consisting of epithelium | | | | | |
| Blood pressure | 86 | 3 | 86 | 11 | 12.79% |
| Shoulder joint - range of | 28 | 3 | 12 | 0 | 0.00% |
| movement | | | | | |
| Anesthetic agent concentration | 26 | 3 | 12 | 0 | 0.00% |
| Wrist joint - range of | 19 | 3 | 8 | 0 | 0.00% |
| movement | | | | | |
| Hip joint - range of movement | 19 | 3 | 12 | 0 | 0.00% |
| Feature of artificial lens | 19 | 3 | 8 | 0 | 0.00% |
| Eating, drinking and/or | 16 | 3 | 12 | 1 | 8.33% |
| feeding activity | | | | | |
| Elbow joint - range of | 13 | 3 | 7 | 0 | 0.00% |
| movement | | | | | |
| Finger joint - range of | 13 | 3 | 10 | 0 | 0.00% |
| movement | | | | | |
| Ankle joint - range of | 13 | 3 | 5 | 0 | 0.00% |
| movement | | | | | |
| Moving in the environment | 12 | 3 | 4 | 0 | 0.00% |
| Knee joint - range of | 11 | 3 | 4 | 0 | 0.00% |
| movement | | | | | |
| Erythrocyte feature | 10 | 3 | 3 | 0 | 0.00% |
| Use of language | 9 | 3 | 9 | 0 | 0.00% |
| Urine output observable | 8 | 3 | 8 | 0 | 0.00% |
| Musculoskeletal rotation | 7 | 3 | 7 | 0 | 0.00% |
| Caregiver emotional health | 5 | 3 | 5 | 0 | 0.00% |
| status | | | | | |
| Community risk control | 5 | 3 | 5 | 0 | 0.00% |
| behavior | | | | | |
| Acoustic feature of mass | 5 | 3 | 5 | 0 | 0.00% |
| Ability to manage medication | 4 | 3 | 4 | 0 | 0.00% |
| Heart rate | 4 | 3 | 4 | 0 | 0.00% |
| Platelet feature | 4 | 3 | 4 | 0 | 0.00% |
| Leukocyte feature | 3 | 3 | 3 | 0 | 0.00% |
| Naming | 1 | 3 | 1 | 0 | 0.00% |
| Micturition | 1 | 3 | 1 | 0 | 0.00% |
| Defecation | 1 | 3 | 1 | 0 | 0.00% |
| Bowel control, function | 1 | 3 | 1 | 0 | 0.00% |
| Bladder control, function | 1 | 3 | 1 | 0 | 0.00% |
| Left ventricular ejection | 1 | 3 | 1 | 0 | 0.00% |
| fraction | | | | | |
| Right ventricular ejection | 1 | 3 | 1 | 0 | 0.00% |
| fraction | | | | | |
| Lifting | 1 | 3 | 1 | 0 | 0.00% |
| Color of sputum | 1 | 3 | 1 | 0 | 0.00% |
| Temperature of vagina | 1 | 3 | 1 | 0 | 0.00% |
| Shoulder joint temperature | 1 | 3 | 1 | 0 | 0.00% |
| Elbow joint temperature | 1 | 3 | 1 | 0 | 0.00% |
| Wrist joint temperature | 1 | 3 | 1 | 0 | 0.00% |
| Thumb joint temperature | 1 | 3 | 1 | 0 | 0.00% |
| Finger joint temperature | 1 | 3 | 1 | 0 | 0.00% |
| Knee joint temperature | 1 | 3 | 1 | 0 | 0.00% |
| Ankle joint temperature | 1 | 3 | 1 | 1 | 100.00% |
| Foot joint temperature | 1 | 3 | 1 | 0 | 0.00% |
| Toe joint temperature | 1 | 3 | 1 | 0 | 0.00% |
| Odor of urine | 1 | 3 | 1 | 0 | 0.00% |
| Odor of sputum | 1 | 3 | 1 | 0 | 0.00% |
| Personal wellbeing status | 1 | 3 | 1 | 0 | 0.00% |
| Community health status: | 1 | 3 | 1 | 0 | 0.00% |
| immunity | | | | | |
| Community disaster readiness | 1 | 3 | 1 | 0 | 0.00% |
| status | | | | | |
| Level of comfort of | 1 | 3 | 1 | 0 | 0.00% |
| environment | | | | | |
| Norton pressure sore risk | 1 | 3 | 1 | 0 | 0.00% |
| score | | | | | |
| Number of right regional | 1 | 3 | 1 | 0 | 0.00% |
| lymph nodes involved by | | | | | |
| malignant neoplasm | | | | | |
| Braden pressure sore risk | 1 | 3 | 1 | 0 | 0.00% |
| score | | | | | |
| Number of left regional | 1 | 3 | 1 | 0 | 0.00% |
| lymph nodes involved by | | | | | |
| malignant neoplasm | | | | | |

Table 6 shows the distribution of clusters, concepts, sample concepts, and erroneous concepts among the six bins. The mean cluster error rate column shows the average error rate of clusters in each bin.

TABLE 6
The distribution of concepts, errors, and error rates among the six bins.

| | Cluster | # of | # of | #Concepts/ | # of | # of | Mean cluster |
|---|---|---|---|---|---|---|---|
| Bin | Size | Clusters | Concepts | #Clusters | Sample | Erroneous | error rate |
| 1 | >150 | 5 | 6,198 | 1239.6 | 219 | 10 (4.56%) | 5.1% |
| 2 | 86-150 | 6 | 665 | 110.83 | 221 | 16 (7.24%) | 4.3% |
| 3 | 46-85 | 7 | 482 | 68.86 | 186 | 3 (1.08%) | 1% |
| 4 | 11-45 | 27 | 572 | 21.19 | 231 | 5 (2.16%) | 1% |
| 5 | 2-10 | 46 | 225 | 5 | 214 | 3 (1.40%) | 1.8% |
| 6 | 1 | 89 | 89 | 1 | 89 | 2 (2.25%) | 2.3% |
| Total | | 180 | 8,231 | 45.98 | 1160 | 39 (3.36%) | 2.0% |

The pairwise statistical differences of mean cluster error rates among the bins was calculated. The error rates and 95% confidence intervals versus cluster size were calculated between all bins. Bin 1 (clusters with more than 150 concepts) had an error rate significantly higher than Bin 3 (46-85 concepts) and Bin 4 (clusters with 11-45 concepts), with p=0.019 and p=0.009, respectively. Furthermore, Bin 2 (85-150 concepts) had an error rate significantly higher than Bin 4 (p=0.039). Error rates between other pairs of bins were not significantly different. However, in general, Bin 1 and 2 clusters have higher mean error rates than clusters in Bins 3-4.

A value of 50 was chosen as the boundary between large and small clusters, providing a relatively balanced sample with 548 concepts in large vs. 612 concepts in small clusters.

Table 7 provides a summary of a review broken down by TAN level and small or large clusters. Large clusters had 26 erroneous concepts (4.75%) and small clusters had 13 erroneous concepts (2.12%). Thus, concepts in large clusters are more likely to have errors than those in small clusters with a statistical significance with p=0.0145 using Fisher's exact two-tailed test. Boundary values of 10, 20, 30, and 40 separating large and small clusters were further and the same observation was statistically significant was found with p=0.0356, p=0.0068, p=0.0016, and p=0.0014, respectively.

TABLE 7
Number of errors breakdown with small vs.
large for three levels in the sample.

| | # of Erroneous Concepts (%) | | # of Sample Concepts | |
|---|---|---|---|---|
| | Large | Small | Large | Small |
| Level 1 | 6 (2.86%) | 7 (3.33%) | 210 | 210 |
| Level 2 | 9 (3.57%) | 4 (1.80%) | 252 | 222 |
| Level 3 | 11 (12.8%) | 2 (1.11%) | 86 | 180 |
| Total | 26 (4.75%) | 13 (2.12%) | 548 | 612 |

For the 39 erroneous concepts, a total of 42 errors were. These erroneous concepts served as targets for 42 different relationships from source hierarchies. A follow up review of these erroneous concepts was followed up using the January 2013 release of SNOMED and all of the errors were still present.

The concepts of large clusters in Levels 3, 2, and 1 have 12.8%, 3.57% and 2.89% errors, respectively. Comparing Level 3 to Levels 1 and 2 statistical significance was found with p=0.0219 and p=0.0048, respectively. Comparing Level 1 to Level 2 the hypothesis was not statistically significant (p=0.6878) in our sample. Table 8 provides five examples of errors identified.

TABLE 8
A sample of five errors taken from our auditing results.

| Concept(s) | Error | Suggested solution |
|---|---|---|
| Sitting systolic | Missing parent: | Add IS-A relationships |
| blood pressure | Sitting | from sitting systolic |
| and Sitting | blood pressure | blood pressure and |
| diastolic blood | | sitting diastolic |
| pressure | | blood pressure to |
| | | Sitting blood pressure. |
| Ankle joint | Incorrect parent: | Replace IS-A to Body |
| temperature | Body temperature | temperature by IS-A |
| | | to Joint temperature |
| Date chemotherapy | Missing parent: | Add IS-A to Temporal |
| completed | Temporal | observable. |
| | observable | |
| Dorsalis pedis | Incorrect parent: | Replace IS-A to Blood |
| arterial | Blood pressure | pressure by IS-A to |
| pressure | | Arterial blood |
| | | pressure |
| Autonomic bladder | Missing parent: | Add IS-A to Bladder |
| function | Bladder Junction | function |

### REFERENCES

1. SNOMED CT. Available from: http://www.ihtsdo.org/snomed-ct/
2. Min H, Perl Y, Chen Y, Halper M, Geller J, Wang Y. Auditing as part of the terminology design life cycle. J Am Med Inform Assoc. 2006; 13(6):676-90.
3. Gu H, Elhanan G, Perl Y, et al. A study of terminology auditors' performance for UMLS semantic type assignments. J Biomed Inform. 2012:1042-8.
4. Gu H H, Hripcsak G, Chen Y, et al. Evaluation of a UMLS Auditing Process of Semantic Type Assignments. AMIA Annu Symp Proc. 2007:294-8.
5. Halper M, Wang Y, Min H, et al. Analysis of error concentrations in SNOMED. AMIA Annu Symp Proc. 2007:314-8.
6. Gu H, Perl Y, Geller J, Halper M, Liu L M, Cimino J J. Representing the UMLS as an object-oriented database: modeling issues and advantages. J Am Med Inform Assoc. 2000; 7(1):66-80.
7. Bodenreider O. The Unified Medical Language System (UMLS): integrating biomedical terminology. Nucleic Acids Res. 2004; 32(Database issue):D267-70.
8. Gu H, Halper M, Geller J, Perl Y. Benefits of an object-oriented database representation for controlled medical terminologies. J Am Med Inform Assoc. 1999; 6(4):283-303.
9. Cimino J J, Clayton P D, Hripcsak G, Johnson S B. Knowledge-based approaches to the maintenance of a large controlled medical terminology. J Am Med Inform Assoc. 1994; 1(1):35-50.
10. Sioutos N, de Coronado S, Haber M W, Hartel F W, Shaiu W L, Wright L W. NCI Thesaurus: a semantic model integrating cancer-related clinical and molecular information. J Biomed Inform. 2007; 40(1):30-43.
11. Fragoso G, de Coronado S, Haber M, Hartel F, Wright L. Overview and utilization of the NCI thesaurus. Comp Funct Genomics. 2004; 5(8):648-54.
12. Wang Y, Halper M, Min H, Perl Y, Chen Y, Spackman K A. Structural methodologies for auditing SNOMED. J Biomed Inform. 2007; 40(5):561-81.
13. Wang A Y, Sable J H, Spackman K A. The SNOMED clinical terms development process: refinement and analysis of content. Proc AMIA Symp. 2002:845-9.
14. Ochs C, Agrawal A, Perl Y, et al. Deriving an Abstraction Network to Support Quality Assurance in OCRe. AMIA Annu Symp Proc. 2012:681-9.
15. Ochs C, He Z, Perl Y, Arabandi S, Halper M, Geller J. Choosing the Granularity of Abstraction Networks for Orientation and Quality Assurance of the Sleep Domain Ontology. Proc of the 4th International Conference on Biomedical Ontology. 2013:84-9.
16. He Z, Ochs C, Soldatova L, Perl Y, Arabandi S, Geller J. Auditing Redundant Import in Reuse of a Top Level Ontology for the Drug Discovery Investigations Ontology 2013 Workshop on Vaccine and Drug Ontology Studies. 2013.
17. He Z, Ochs C, Agrawal A, et al. A Family-Based Framework for Supporting Quality Assurance of Biomedical Ontologies in BioPortal. AMIA Annu Symp Proc (to appear). 2013.
18. Tu S, Carini S, Rector A, et al. OCRe: An Ontology of Clinical Research. 11th International Protege Conference; 2009.
19. Arabandi S, Ogbuji C, Redline S, et al. Developing a Sleep Domain Ontology. AMIA Clinical Research Informatics Summit. San Francisco; 2010.
20. Qi D, King R D, Hopkins A L, Bickerton G R J, Soldatova L N. An Ontology for Description of Drug Discovery Investigations. Journal of Integrative Bioinformatics. 2010; 7(3).
21. Zeginis D, Hasnain A, Loutas N, Deus H F, Foxc R, Tarabanis K. A collaborative methodology for developing a semantic model for interlinking Cancer Chemoprevention linked-data sources. Semantic Web. 2013:1-16.
22. IHTSDO. International Health Terminology Standards Development Organization (IHTSDO). 2012 [cited 2013 9 Sep. 2013]; Available from: http://www.ihtsdo.org/
23. CliniClue Xplore. [cited; Available from: http://www.cliniclue.com/software
24. Gu H, Perl Y, Elhanan G, Min H, Zhang L, Peng Y. Auditing concept categorizations in the UMLS. Artif Intell Med. 2004; 31(1):29-44.
25. Chen Y, Gu H, Perl Y, Geller J, Halper M. Structural group auditing of a UMLS semantic type's extent. J Biomed Inform. 2009; 42(1):41-52.
26. Chen Y, Gu H, Perl Y, Halper M, Xu J. Expanding the extent of a UMLS semantic type via group neighborhood auditing. J Am Med Inform Assoc. 2009; 16(5):746-57.
27. Wang Y, Halper M, Wei D, Perl Y, Geller J. Abstraction of complex concepts with a refined partial-area taxonomy of SNOMED. J Biomed Inform. 2012; 45(1):15-29.
28. Wang Y, Halper M, Wei D, et al. Auditing complex concepts of SNOMED using a refined hierarchical abstraction network. J Biomed Inform. 2012; 45(1):1-14.
29. Ochs C, Perl Y, Geller J, et al. Scalability of Abstraction-Network-Based Quality Assurance to Large SNOMED Hierarchies. AMIA Annu Symp Proc (to appear). 2013.
30. Wei D, Bodenreider O. Using the abstraction network in complement to description logics for quality assurance in biomedical terminologies—a case study in SNOMED CT. Stud Health Technol Inform. 2010; 160(Pt 2):1070-4.
31. Shearer R, Motik B, Horrocks I. HermiT: a highly-efficient OWL reasoner. Proceedings of the 5th International Workshop on OWL: Experiences and Directions. 2008.
32. FACT++. [cited 2013 9 Sep.]; Available from: http://code.googlecom/p/factplusplus/
33. Rector A L, Brandt S, Schneider T. Getting the foot out of the pelvis: modeling problems affecting use of SNOMED CT hierarchies in practical applications. J Am Med Inform Assoc. 2011; 18(4):432-40.
34. Rector A L, Iannone L. Lexically suggest, logically define: Quality assurance of the use of qualifiers and expected results of post-coordination in SNOMED CT. J Biomed Inform. 2011; 45(2):199-209.
35. Schulz S, Hahn U, Rogers J. Semantic Clarification of the Representation of Procedures and Diseases in SNOMED®CT. Stud Health Technol Inform. 2005; 116:773-8.
36. Schulz S, Hanser S, Hahn U, Rogers J. The semantics of procedures and diseases in SNOMED CT. Methods Inf Med. 2006; 45(4):354-8.
37. Schulz S, Suntisrivaraporn B, Baader F, Boeker M. SNOMED reaching its adolescence: ontologists' and logicians' health check. Int J Med Inform. 2009; 78 Suppl 1:S86-94.
38. Zhu X, Fan J W, Baorto D M, Weng C, Cimino J J. A review of auditing methods applied to the content of controlled biomedical terminologies. J Biomed Inform. 2009; 42(3):413-25.
39. SNOMED CT User Guide. [cited 2013 9 Sep.]; Available from: http://www.snomed.org/ug
40. Cormen T H, Leiserson C E, Rivest R L, Stein C. Introduction to Algorithms: MIT Press and McGraw-Hill; 2001.
41. Elhanan G, Perl Y, Geller J. A survey of SNOMED CT direct users, 2010: impressions and preferences regarding content and quality. J Am Med Inform Assoc. 2011; 18 Suppl 1:i36-44.
42. US Edition of SNOMED CT. 2013 September 2013 [cited 2013 9 Sep.]; Available from: http://www.nlm.nih.gov/research/umls/Snomed/us_edition.html
43. Fisher R A. Statistical Methods for Research Workers. 14 ed: Macmillan Pub Co; 1970.
44. Geller J, Ochs C, Perl Y, Xu J. New Abstraction Networks and a New Visualization Tool in Support of Auditing the SNOMED CT Content. AMIA Annu Symp Proc. 2012:237-46.

1. A tribal abstraction network which is comprised of a summarization of a terminology with an ISA (subclass) hierarchy without lateral relationships
wherein the children of the hierarchy's root are named patriarchs;
a subhierarchy consisting of a patriarch and all its descents is named a tribe;
every concept in the hierarchy belongs to at least one tribe; and
all concepts belonging to a common set of tribes are grouped together into a set called a band.

2. The tribal abstraction network of claim 1 which is a band tribal abstraction network consisting of a set of nodes representing bands within the tribal abstraction network where each band represents a set of all concepts that belong to a common set of tribes.

3. The tribal abstraction network of claim 2 wherein a band may have multiple roots where each root defines a different subhierarchy of concepts within the band.

4. The tribal abstraction network of claim 1 which is a cluster tribal abstraction network wherein a cluster is represented as a node of the cluster tribal abstraction and each cluster represents a set of concepts consisting of a root of a band and all its descendant concepts within the same band.

5. The tribal abstraction network of claim 1 wherein the terminology is SNOMED.

6. A method of to derive a tribal abstraction network for a hierarchy which comprises
a. identifying patriarchs which are the children of the hierarchy root;
b. identifying tribes wherein each tribe is a subhierarchy consisting of a patriarch and all its descendants; and
c. assigning each concept by its set of tribes by traversing the hierarchy using a topological sort starting from the hierarchy's patriarchs;
wherein concepts that belong to multiple tribes are grouped into sets by specific combinations of tribes.

7. A method of carrying out quality assurance of a terminology with an ISA (subclass) hierarchy without lateral relationships which comprises
using a tribal abstraction network to identify large clusters within the tribal abstraction network;
identifying the concepts belonging to large clusters at higher-numbered levels, and reviewing the identified concepts for errors.
